(19) United States
(12) Patent Application Publication
(10) Pub. No.: US 2011/0037569 A1
(43) Pub. Date: Feb. 17, 2011

(54) COVERING AND/OR SEALING FOIL FOR A PACK AND METHOD AND SYSTEM FOR DETERMINING THE OPEN STATE OF A PACK

(75) Inventor: Michael Kiy, Winterthur (CH)

Correspondence Address: RATNERPRESTIA, P.O. BOX 980, VALLEY FORGE, PA, 19482, US

(73) Assignee: AMCOR FLEXIBLES KREUZLINGEN, Kreuzlingen (CH)

(21) Appl. No.: 12/990,012

(22) PCT Filed: Apr. 16, 2009
(86) PCT No.: PCT/EP09/02781

§ 371 Date: Oct. 28, 2010

(30) Foreign Application Priority Data
Apr. 28, 2008 (EP) 08008089.8

(51) Int. Cl. H04Q 5/22

(52) U.S. Cl. 340/10.1

(57) ABSTRACT

The invention relates to a covering and/or sealing foil for a pack, in particular blister pack, configured to seal at least one filling compartment and to enable access to the filling compartment by separation and/or tearing, wherein the film, in particular in the region of the filling compartment, has a predetermined electroconductive property, which can be contacted for electronic evaluation and, as a reaction to the separation or tearing, undergoes a change that can be evaluated, wherein the electroconductive property influences the oscillation frequency of an electrical frequency generator unit which is formed on the foil and the frequency generator unit is configured to cooperate with an antenna which is formed on the foil by means of an antenna strip conductor in such a way that the antenna and/or an associated electrical capacitance causes electrical energy to be supplied to the frequency generator unit and the frequency generator unit modulates an antenna signal of the antenna by means of the oscillation frequency.

The present invention relates to a covering and/or sealing foil for a pack, in particular a blister pack, according to the preamble of the main claim. The invention also relates to a method for determining the open state of a pack which is sealed by means of a covering and/or sealing foil, the use of a covering and/or sealing foil and a system for determining the open state of a pack which is sealed by means of a covering and/or sealing foil.

A generic covering and/or sealing foil of this type is generally known from the prior art, for example in the form of a medicament blister pack, in which the sealing foil carries an electric strip conductor, which is associated with a filling compartment in such a way that the electrically conductive strip is destroyed on (manual) access to the medicament in the filling compartment and it can thus be established by electronic evaluation of the conductive behaviour of the strip conductor whether the filling chamber has been opened. EP 0 972 507 A1 discloses a known covering or sealing foil of this type, a plurality of filling compartments and, correspondingly, a more complex strip conductor structure being described here, which is electronically evaluated with regard to a total ohmic resistance; according to this disclosure from the prior art, the local tearing or separation leads to an interruption of a respective strip conductor (resistance-loaded), with a corresponding effect on the total resistance (electronically evaluated) of the strip conductor arrangement.

Various procedures are known from the further prior art for evaluating or further processing the open signal obtained in the above described manner; thus it is, for example, known in the pharmaceutical industry sector that suitable strip conductors, which can be contacted at the edge, for example, of a generic covering foil are connected to a so-called data logger, which detects any change in the conductive properties, in other words, for example, the total resistance present, and provides it with a time stamp and thus provides the possibility of monitoring access or removal times for the relevant pack. It is also known in this context to use a (typically directly contacted) evaluation system in order to indicate, in the manner of a warning, an access which has not taken place (i.e., for example, when there is a lack of a detected opening).

Moreover, it is known from unpublished prior art, internal to the Applicant, to provide wirelessly effective evaluation means, for example by means of current RFID technology, on the covering or sealing film in such a way that, as a reaction to the change in the conductive property, a (typically) digital evaluation and conversion to a detection signal takes place, which is processed in an otherwise known manner in the framework of RFID data protocols and is wirelessly transmitted for further external processing. However, the production outlay here, in particular for each pack or covering foil to be equipped in this manner, is very high and there is the added factor that expensive integrated electronic modules are necessary.

The object of the present invention is therefore to provide a covering and/or sealing foil for a pack, in particular a blister pack, according to the preamble of the main claim with regard to simplifying the hardware outlay on the foil, simultaneously to enable a wireless transmission or retrieving of an open state signal and to provide a device which can be operated with low electrical energy consumption. Furthermore, a new use for a covering or sealing foil of this type and a pack sealed therewith is to be provided, and an improved method for detecting and wirelessly transmitting the open state of a pack which is sealed with a covering and/or a sealing film is to be provided, which combines high operating reliability and with low energy consumption and easy producibility and handleability.

The object is achieved by the covering and/or sealing foil having the features of the main claim, also by the use according to the independent claim 12, the method according to the independent claim 14 and the system according to the independent claim 16. Advantageous developments of the invention are described in the sub-claims.

Formed on the covering or sealing foil in an advantageous manner according to the invention is a frequency generator unit, the oscillating frequency of which is directly influenced by the electroconductive property of the foil or a foil portion (i.e. ohmic resistance and/or electrical capacitance), the electroconductive property being changed upon an access to one of the respective filling compartments (due to separation or tearing), in particular in a use for blister packs and/or with a plurality of filling compartments. The electrical frequency generator unit, in the scope of the invention, is supplied by the antenna (more precisely: an electromagnetic alternating signal wirelessly input into the antenna) or an electrical capacitance associated with the antenna, with energy, and modulates the antenna signal which is wireless radiated by the antenna by means of the oscillation frequency.

It is therefore suitably and, in particular preferably, possible to provide the foils even without a battery or other autonomous electrical current supply; instead, the operating voltage is supplied merely by externally and wirelessly supplied energy, which is optionally buffered by the associated electrical capacitance, which can also be produced according to the development by a suitable capacitive portion on the foil.

The modulation according to the invention of the antenna signal (or the oscillating circuit produced by means of the antenna) takes place according to the developments by periodic or temporary short-circuiting of this oscillating circuit, the oscillation frequency signal of the frequency generator unit suitably activating a correspondingly associated electronic switching element to short-circuit in the realisation according to the development.

Within the scope of the invention it is, on the one hand, provided that a change of an ohmic resistance (for example in the case of multiple filling compartments an ohmic parallel resistance) be evaluated in accordance with the individual resistances associated with the filling chamber (or respective resistance-loaded line portions of the foil) with regard to the open state, and in addition or alternatively, it is within the scope of the invention to provide the foil according to the invention capacitively or with capacitively acting portions (capacitor portions), which can be evaluated with regard to a total capacitance (as a parallel connection), and depending on the local opening state of individual filling compartments, can be monitored for changes or deviations with regard to their influence on the total capacitance.

The provision of capacitor portions, in particular, is made possible in accordance with the development and in the scope of preferred embodiments (best mode) of the invention in that capacitor structures consisting of an electrode layer pair with an interposed dielectric layer are produced over the whole area or locally, with suitable strip conductor feed lines on the foil bringing about the (typically parallel) total circuit, depending on the configuration.

In this case, the present invention comprises configuring the preferably provided capacitively active portion which is associated with a respective filling compartment directly for covering or sealing the filling compartment and evaluating the capacitance change thereof to detect the open state, and also to separate or tear a feed line to a capacitor of this type to detect the open state, so the relevant capacitively active portion then no longer contributes to the formation of the total capacitance (by parallel connection). It is also advantageous, in this case, to provide only a simple strip conductor structure in the covering or sealing foil, which switches, electrically in parallel, a plurality of capacitively active portions associated with respective filling compartments (and therefore adds them with regard to the total capacitance thereof).

An important advantage of the present invention is that—while avoiding a standardised integrated RFID chip—the electronic components can be produced by printed or printable production methods. The simple procedure according to the invention for oscillation generation and the modulation thereof is thus an intended departure from (comparatively complex) RFID protocols, which, in a conventional realisation, would require corresponding integrated switching circuits; the present invention, in contrast, provides a significant topological simplification, which is accordingly expressed in a drastically reduced production outlay while avoiding complex integrated components and protocols implemented therewith.

The realisation of the present invention also provides numerous further advantages in terms of process technology; it is thus favourable according to preferred developments, on the one hand, with regard to series production, to apply at least one layer producing an electrode by a vapour deposition, lamination or other application methods of a metal on a substrate (which itself can in turn also serve as a dielectric); in addition or alternatively, a conductive layer may be produced by lacquering (with correspondingly conductive lacquer), by application of a conductive polymer or the like, just as the dielectric layer can be generated by means of, for example, an insulating lacquer layer or by chemical treatment of an adjacent electrode layer (for example by oxidation of a surface thereof). In particular the variant which is last-mentioned also offers the advantage that, in a manner which is elegant in terms of process technology and simultaneously optimised electrotechnically, for example by etching or similar chemical or electrochemical measures, an effective surface enlargement of a metal layer (serving as the first electrode) is carried out, there is a subsequent oxidation of this surface-enlarging metal layer (for example as an aluminium layer to aluminium oxide), the corresponding large-area dielectric layer is generated and a subsequent vapour deposition of the dielectric layer with conductive material provides the counter-electrode. A large effective capacitance area can thus be generated on an optimised foil area, which in addition promises, in particular, a large-scale favourable producibility. The same applies to the capacity to manufacture ohmic resistance areas.

It is also particularly elegantly possible in terms of processing terminology in the scope of the invention to produce the—comparatively simple—circuit arrangement without the necessity for integrated switching circuits by means of printed strip conductors, inexpensively and with a low outlay; the technology according to the invention therefore allows, in a very much more favourable manner than the prior art cited, the use of printing technology which is suitable for large-scale production. In particular, it is therefore a developing feature of the invention to produce the frequency generator unit according to the invention only by means of discrete electronic components and preferably without integrated semiconductor modules, in particular silicon-based integrated semiconductor components.

It is therefore also within the scope of a preferred development of the invention to provide coding portions on the foil by means of ohmic resistance regions and/or capacitance regions (portions) in such a way that, depending on the inclusion of these portions in the frequency generator unit, a preadjustment of oscillation frequencies or oscillation frequency regions can take place, so that an individual adaptation of a rather generally held basic design can, in particular, also take place to various use conditions or characterisation requirements.

It is also within the scope of the invention to provide a method for determining the open state of a pack, in particular blister pack, which is sealed by means of a covering and/or sealing foil, the invention in particular also including the operation of the above-described covering and/or sealing foil according to the invention with the purpose of detecting an open state of a relevant filling compartment. In the scope of the present disclosure, in particular, all the disclosed method features in conjunction with the covering and/or sealing film are also, in this case, to be considered to have been disclosed as belonging to the method invention.

Finally, it is within the scope of the invention to provide the covering and/or sealing foil according to the invention together with a (wirelessly connected) detection unit, which is, in particular, configured to detect an oscillation frequency or a change thereof that is representative (of an open state or a change thereof) and to make it accessible to further evaluation. A unit of this type which is itself stationary or can be set up in a mobile manner, in cooperation with the covering and/or sealing foil of the invention (or a pack provided therewith), then provides diverse possibilities for detecting an open state or also for logistic processing and monitoring, in particular, time sequences of an open state change, and/or a plurality of pack units (optionally suitably coded or preadjusted by means of their oscillation frequency) also being able to be treated in the scope of developments of the invention.

The present invention, because of its high degree of suitability for large-scale production (through simple producibility and low hardware outlay) is suitable for any pack applications, the invention proving particularly favourable in particular in conjunction with blister packs. In principle, the range of applications of covering or sealing foils of this type and packs which are sealed thereby, is also as desired, but, in particular, use in the area of medicaments or other pharmaceutical products should prove to be particularly suitable, not least because of the advantageous logistic and monitoring properties by means of the present invention.

The present invention therefore provides, in a surprisingly simple and elegant manner, a method of providing, reliably and in a manner which can be precisely evaluated, open state recognition for a plurality of filling compartments to be sealed with the covering and/or sealing foil, it being possible to link lower pack hardware outlay with a high degree of suitability for large-scale production, great operating reliability and the most flexible application possibilities.

Further advantages, features and details of the invention emerge from the following description of preferred embodiments and with the aid of the drawings, in which:

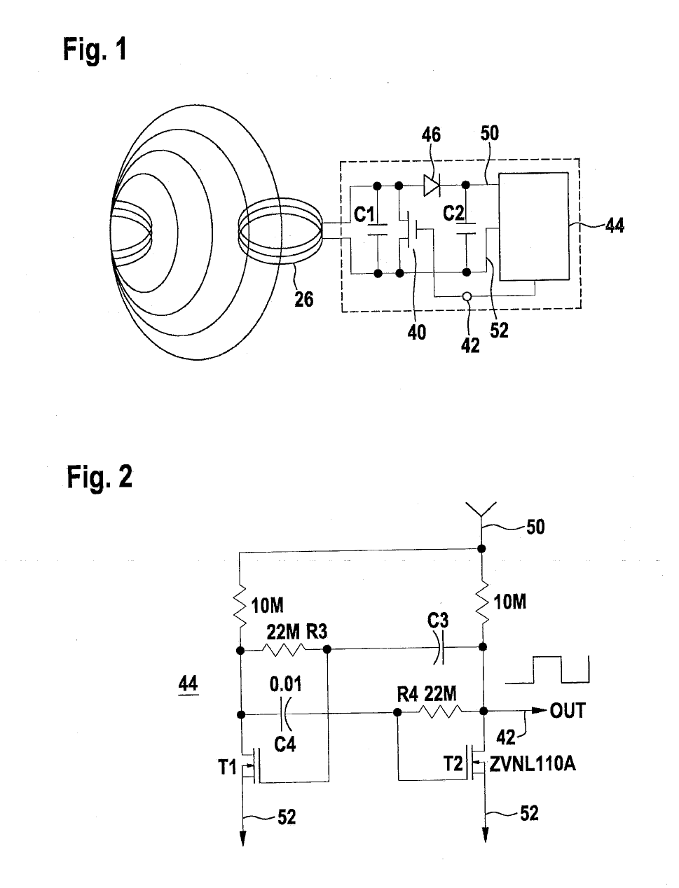

FIG. 1 shows a schematic circuit diagram of the technical functionality of the covering and/or sealing foil according to a first preferred embodiment of the present invention;

FIG. 2 shows a circuit diagram of an oscillator circuit used by way of example to produce the frequency generator unit of FIG. 1;

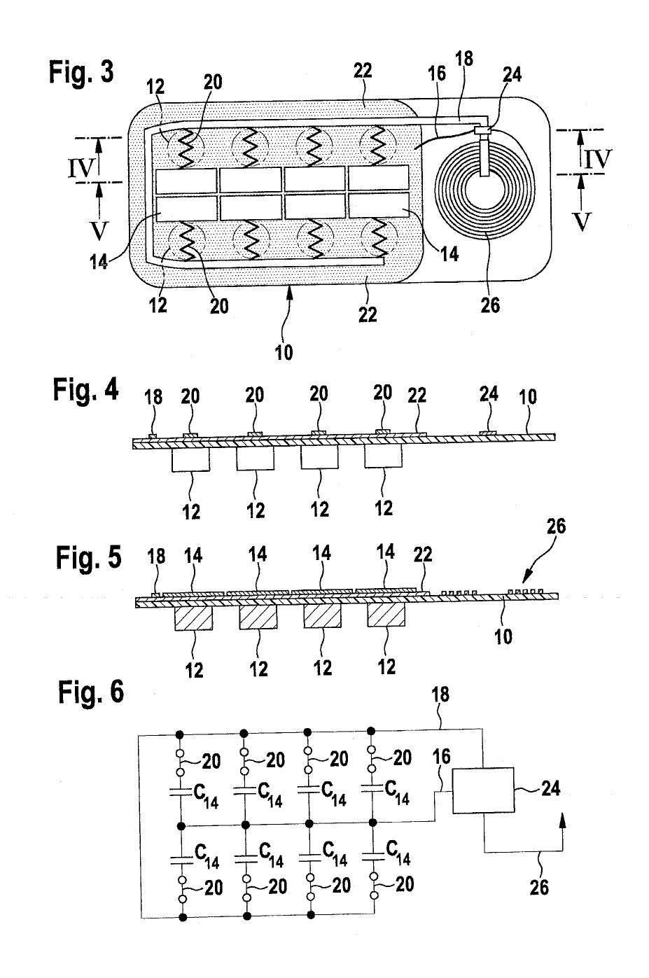

FIG. 3 shows a plan view of the foil layout of a blister pack which is sealed by means of the covering or sealing foil in the embodiment of FIG. 1;

FIG. 4, FIG. 5 show sectional views of the layer structure of the foil according to FIG. 3 and

FIG. 6 shows a circuit diagram of the parallel circuit produced in the foil layout in FIGS. 3 to 5 of capacitor portions associated in each case with filling compartments.

FIG. 1 illustrates, as a schematic circuit diagram, the mode of functioning in principle (in terms of signal) of a covering and/or sealing foil according to a first embodiment of the present invention. An antenna 26, shown schematically as a coil and produced by means of printed strip conductors forms, with a capacitor C1 which is connected in parallel thereto, an LC circuit, which is matched or adjusted to a suitable carrier frequency (for example 13.56 MHz). Connected in parallel to this oscillating circuit is a field effect transistor 40 as a switching unit, which receives its gate signal by way of a timing circuit 42 from a frequency generator unit 44, which will be described in detail below. As illustrated in FIG. 1, the antenna 26 or an external signal which is input there is applied by way of a rectifier diode 46 and a buffer capacitor C2 as a voltage supply to the frequency generator unit 44.

FIG. 2, using the example of a (substantially generic) oscillator unit, produced as a bistable multivibrator, illustrates a possible realisation of the frequency generator unit 44. Two transistors T1, T2 which are arranged in the manner shown (and typically produced as an integrated switching circuit) are connected to produce a rectangular output signal OUT to the control line 42, the capacitors C3 and C4 and the resistances R3 and R4 determining or influencing the frequency of the oscillator output signal (oscillation frequency). The connections 50 or 52 (cf. also FIG. 1) supply operating voltage or ground.

In the circuit diagram of FIG. 2, the electronic components are provided with respective typical parameters or types, the capacitor C3, in the example shown, being produced by a parallel connection of individual capacitances (capacitances) (produced by means of capacitive portions of the covering or sealing foil), and, depending on the open state of the associated filling compartments, individual capacitors contributing to the total capacitance C3 or remaining disregarded in the case of an open state.

For further explanation, with reference to FIGS. 3 to 6, it will be explained below how the total capacitance C3 is formed on the covering or sealing foil according to the embodiment shown and changes upon access to a filling compartment.

FIG. 3 shows a plan view of how a covering foil 10 which is to seal a total of eight filling compartments 12 is provided in the manner of an otherwise known blister carrier unit. The foil 10, which is itself produced from an insulating material, for example a plastics material film carries, on one portion, an aluminium foil 22, which is in turn coated in an insulating manner with a lacquer. The aluminium foil 22 therefore forms a first, large-area electrode of the device as a counter-electrode for eight second electrode portions 14 which are associated with the respective filling compartments 12 and is contacted by a first feed line 16. The respective second electrodes (electrode areas) 14 are contacted in the manner shown in FIG. 1 in a U-shape by a second feed line 18 and, in each case by conductor pieces 20 formed in a meandering manner, so in the manner shown in FIG. 6, a parallel connection of the individual capacitances C₁₄ is produced in accordance with a respective capacitance formed by an electrode area 14 relative to the (coated) aluminium foil 22. Specifically, the second feed line 18, the feed lines 20 and the electrode areas 14 are formed here as conductive portions (for example realised by means of conductive dye or conductive polymer) on the lacquer of the coated aluminium foil 22 acting as a dielectric.

In the embodiment shown, each of the areas 14 is, in this case, about 2 cm² in size, the lacquer used for the production of the insulating intermediate layer on the conductive layer 22 (dielectric) typically being applied in a lacquer thickness of 2 μm and having a dielectric constant ∈ᵣ of 3. This then leads to a capacitance C₁₄ in the order of magnitude of about 27 nF which, depending on the open state of the filling compartments (in the case of opening of the blister pack, the respective feed line 20 would be separated) contributes to the parallel connection of all capacitors applied to the two-terminal network 16, 18 or else is switched off thereby by the separation.

The opening detection unit which is formed from the units 12 to 22, which with regard to the connections 16 or 18 is the two-pole network and, as described, has the total capacitance C₃ formed by the addition of the individual capacitances C₁₄ (see FIG. 2), is evaluated in the manner shown in FIG. 1 and described above.

During use of the device shown, a user now removes the filling product contained in a respective compartment 12, for example a tablet, in that the covering film 10 in the region of the relevant compartment 12 is locally separated or torn in the otherwise known manner, resulting in the fact that the connection line piece 20 is separated. Consequently, indicated by the symbolic switch unit in the circuit diagram of FIG. 6, the connection to the relevant capacitor is electrically separated (opened) so this capacitor no longer contributes to the total capacitance C₃. Accordingly, the total capacitance C₃ is reduced by the amount of the relevant capacitance, this taking place in the manner of a subtraction of the capacitance value in the example described of the parallel connection of the capacitances.

The capacitance C₃ thus reduced then influences the oscillation behaviour of the frequency generator unit in the manner described above in conjunction with FIGS. 1 and 2, so an external open state detection can take place in the described manner.

The present invention is not limited to the embodiment shown nor to the capacitive open state detection shown, in particular a (virtually any) realisation with other capacitance configurations and/or ohmic resistance configurations is also possible.

1. A covering and/or sealing foil for a pack configured to seal at least one filling compartment and to enable access to the filling compartment by separation and/or tearing, wherein the film has a predetermined electroconductive property, which can be contacted for electronic evaluation and, as a reaction to the separation or tearing, undergoes a change that can be evaluated, wherein the electroconductive property influences the oscillation frequency of an electrical frequency generator unit formed on the foil and the frequency generator unit is configured to cooperate with an antenna formed on the foil by means of an antenna strip conductor in such a way that the antenna and/or an associated electrical capacitance causes electrical energy to be supplied to the frequency generator unit and the frequency generator unit modulates an antenna signal of the antenna by means of the oscillation frequency.

2. A foil according to claim 1 wherein no battery or other autonomous electrical current supply is provided on the foil.

3. A foil according to claim 1 wherein the modulation is brought about by temporary short circuiting of an LC circuit formed by the antenna.

4. A foil according to claim 1 wherein the conductive property includes a resulting ohmic resistance of a parallel resistor circuit of ohmic resistor portions, which are associated with a plurality of filling compartments and, as a reaction to the separation or tearing, are electrically separated from the parallel resistor circuit.

5. A foil according to claim 4 wherein the resistor portions are realised by means of strip conductor portions which are formed on the foil and/or are electrically contacted.

6. A foil according to claim 1 wherein the conductive property is a resulting electrical capacitance of a parallel capacitor circuit of capacitor portions, which are associated with a plurality of filling compartments and, as a reaction to the separation or tearing, are electrically separated from the parallel capacitor circuit.

7. A foil according to claim 6 wherein a capacitively effective layer structure of the capacitor portions has an electrically conductive electrode layer and a dielectric layer which is formed by an applied insulating lacquer layer or by chemical treatment of the electrode layer.

8. A foil according to claim 6 wherein a capacitively effective layer structure of the capacitor portions has an electrode layer which is formed on a dielectric layer by coating with electrically conductive lacquer or an electrically conductive polymer or by application of a metal layer.

9. A foil according to claim 6 wherein a capacitively effective layer structure of the capacitor portion, at least portion-wise, has an electrode layer pair, the capacitively effective metallic surface of which is enlarged by a chemical or electrochemical treatment.

10. A foil according to claim 4 wherein the ohmic resistor portions and/or the capacitor portions are contacted by an electrical contact and/or strip conductor structure which is formed by means of the foil and are interconnected.

11. A foil according to claim 1 wherein ohmic resistor and/or capacitor portions are additionally provided on the foil, which are contacted in a manner influencing the oscillation frequency and can be decontacted in a controlled manner for coding of the foil in terms of frequency.

12. A method for sealing a blister pack and for detecting an open state of the blister pack which is provided with a plurality of filling chambers, said method comprising using a covering and/or sealing foil according to claim 1.

13. A method according to claim 12, wherein the blister pack is a medicament blister pack.

14. A method for determining the open state of a pack which is sealed by means of a covering and/or sealing foil comprising the steps of:
generating an oscillator signal by means of a frequency generator unit which is formed on the foil with an oscillation frequency influenced by an ohmic resistance and/or electrical capacitance of the foil;
wirelessly detecting the oscillation frequency modulated to a carrier signal; and
determining an open state of the pack as a reaction to the detection.

15. A method according to claim 14 wherein energy is supplied to the frequency generator means only by an electromagnetic alternating signal wirelessly input into the foil.

16. A system for determining the open state of a pack which is sealed by means of a covering and/or sealing foil, comprising a pack having the covering and/or sealing foil according to any one of cl and a detection unit which is wirelessly associated with the pack and is configured for the wireless detection of the oscillation frequency and to generate an open state detection signal as a reaction to the oscillation frequency, a deviation of the oscillation frequency from a predetermined comparison and/or threshold value and/or a frequency change of the oscillation frequency.

17. A foil according to claim 1 wherein the film has a predetermined electroconductive property in the region of the filling compartment.

18. A foil according to claim 3 wherein the temporary short circuiting of the LC circuit formed by the antenna is clocked with the oscillation frequency.

19. A foil according to claim 7 wherein the dielectric layer is formed by oxidation of the electrode layer.

20. A foil according to claim 8 wherein the electrode layer is formed on the dielectric layer by vapour deposition or lamination of a metal layer.

21. A method according to claim 14 wherein the reaction to the detection is a reaction to a detected change of the oscillation frequency.
